(19) United States
(12) Patent Application Publication
(10) Pub. No.: US 2025/0224529 A1
(43) Pub. Date: Jul. 10, 2025

(54) METHOD FOR VALIDATING PALEOGEOGRAPHIC MODELS USING SEISMIC DATA

(71) Applicant: SAUDI ARABIAN OIL COMPANY, Dhahran (SA)

(72) Inventors: Nikolaos A. Michael, Dhahran (SA); Wisam AlKawai, Qatif (SA); Saleh A. Alqahtani, Dhahran (SA)

(73) Assignee: SAUDI ARABIAN OIL COMPANY, Dhahran (SA)

(21) Appl. No.: 18/404,719

(22) Filed: Jan. 4, 2024

(51) Int. Cl. G01V 1/28; G01V 1/30

(52) U.S. Cl. CPC G01V 1/282; G01V 1/306; G01V 2210/63; G01V 2210/661

(57) ABSTRACT

Examples of methods and systems are disclosed. The methods may include obtaining, by a geological modeling system, geological data and seismic data regarding a subsurface region of interest, generating a paleogeographic surface using the geological data and the seismic data, and selecting an adjustable geological attribute from the paleogeographic surface. The methods may also include generating, using a seismic interpretation system coupled to the geological modeling system, a surface of a seismic attribute using the seismic data, where the seismic attribute is related to the adjustable geological attribute. The methods may further include generating, by the geological modeling system, an updated paleogeographic surface, iteratively or recursively, until a stopping condition is reached, based on a difference between the paleogeographic surface and the surface of the seismic attribute, and determining a validated geological model of the subsurface region of interest based, at least in part, on the updated paleogeographic surface.

### BACKGROUND

In the oil and gas industry, operations such as surveying, drilling, wireline testing, completions, production, planning and field analysis, are typically performed to locate and produce valuable hydrocarbons such as oil and gas. Surveys are often performed using acquisition methods such as seismic surveys to generate maps of underground formations. These formations are often analyzed to determine the presence of hydrocarbons and valuable minerals, or to determine if the formations have characteristics suitable for storing fluids.

Sedimentology may determine vertical and lateral distributions of formations within the subsurface and resulting variability in space and time of sediments with specific features. This information may be used by various software programs to map geological formations in two dimensions or three dimensions as well as generate numerical models of sedimentary systems. Sedimentary basin modeling can predict if, and how, a reservoir has been charged with hydrocarbons, including the source and timing of hydrocarbon generation, migration paths, quantities, and hydrocarbon type.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, in general, embodiments disclosed herein relate to a method. The method includes obtaining, by a geological modeling system, geological data and seismic data regarding a subsurface region of interest, generating a paleogeographic surface using the geological data and the seismic data, and selecting an adjustable geological attribute from the paleogeographic surface. The method also includes generating, using a seismic interpretation system, a surface of a seismic attribute using the seismic data, where the seismic attribute is related to the adjustable geological attribute, and the seismic interpretation system is coupled to the geological modeling system. The method further includes generating, by the geological modeling system, an updated paleogeographic surface, iteratively or recursively, until a stopping condition is reached, based on a difference between the paleogeographic surface and the surface of the seismic attribute, and determining a validated geological model of the subsurface region of interest based, at least in part, on the updated paleogeographic surface.

In one aspect, in general, embodiments disclosed herein relate to a system. The system includes a seismic acquisition system configured to record seismic data regarding a subsurface region of interest, a logging system coupled to a plurality of logging tools configured to record geological data regarding the subsurface region of interest, a seismic interpretation system configured to generate a surface of a seismic attribute using the seismic data, and a geological modeling system coupled to the seismic interpretation system. The geological modeling system is configured to obtain the geological data from the logging system and the seismic data from the seismic acquisition system, to generate a paleogeographic surface using the geological data and the seismic data, and to select an adjustable geological attribute from the paleogeographic surface, where the adjustable geological attribute is related to the seismic attribute. The geological modeling system is also configured to generate an updated paleogeographic surface, iteratively or recursively, until a stopping condition is reached, based on a difference between the paleogeographic surface and the surface of the seismic attribute, and to determine a validated geological model of the subsurface region of interest based, at least in part, on the updated paleogeographic surface.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

FIG. 1 shows a drilling system in accordance with one or more embodiments.

FIG. 2 shows examples of seismic images for subsurface structure according to one or more embodiments.

FIGS. 3 and 4 depict an example of a sedimentary basin at various geological times, according to one or more embodiments of the present disclosure.

FIG. 5 shows an example of generating a paleogeographic surface, according to one or more embodiments.

FIG. 6 shows an example of updating a paleo-topography according to one or more embodiments.

FIG. 7 shows an example of generating a calibration surface according to one or more embodiments.

FIGS. 8A and 8B shows examples of comparing a contour from a paleographic surface and an adjustment curve, according to one or more embodiments.

FIG. 9 shows a flowchart in accordance with one or more embodiments.

FIG. 10 shows a flowchart in accordance with one or more embodiments.

FIG. 11 depicts a schematic diagram of a computer system in accordance with one or more embodiments.

### DETAILED DESCRIPTION

In the following detailed description of embodiments of the disclosure, numerous specific details are set forth to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

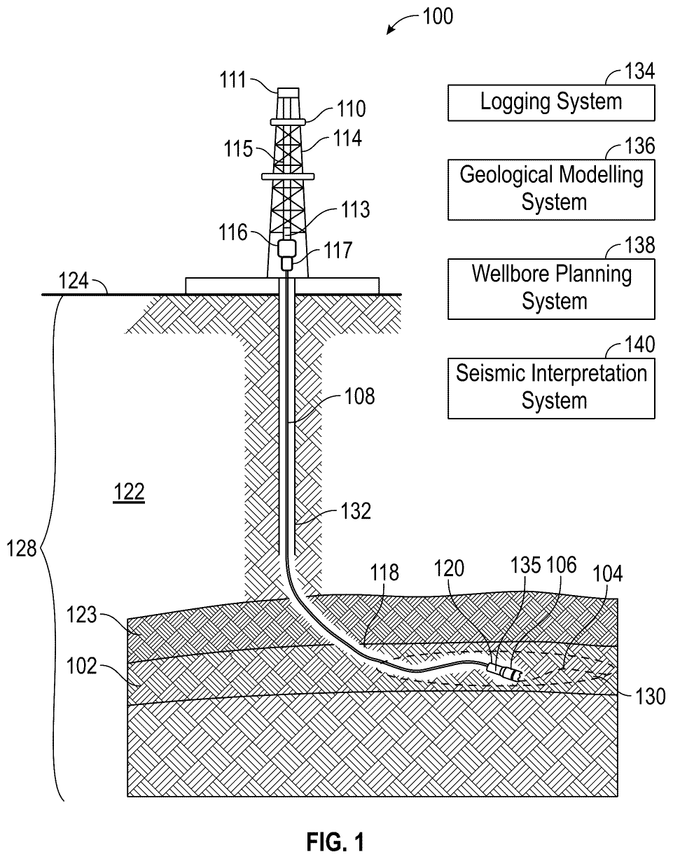

In the following description of FIGS. 1-11, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic signal” includes reference to one or more of such seismic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

In general, disclosed embodiments include systems and methods to generate and validate input parameters for paleogeographic reconstruction using seismic data. In particular, some embodiments validate paleogeographic models used to generate models of sedimentary basins. Modeling paleogeography in sedimentary basins may be based on the understanding and on a combination of the processes controlling the evolution of geological formations and the resulting sedimentary system. Construction of a paleographic model may include different phases such as, interpretation of gross depositional environment (GDE) maps, generation of seismic images, decompaction modeling, seismic attribute extraction, and validation of paleogeographic models.

However, paleogeographic reconstruction is often based on workflows involving various types of data. Input data for paleogeographic reconstruction may include data with known accuracy and data with large uncertainties. Large uncertainties in data (such as in a total relief map) may be reduced by constraining such data with data with known accuracy (such as seismic data). Data constraining may be performed based on geological attributes that may be extracted from both, the large- and low-uncertainty data. For example, geological attributes extracted from data with large uncertainties may be calibrated based on the spatial distribution of (equivalent or correlated) geological attributes extracted from data with better known accuracy. Reducing uncertainty in the reconstruction parameters when reconstructing ancient topography and bathymetry is important for predicting present-day hydrocarbon reservoir quality. Methods and processing techniques to improve the accuracy of input data for paleographic reconstruction may assist in improving the reliability of the generated paleogeographic models.

The resulting paleogeographic models may then be used for petroleum exploration, such as defining the spatial location and extent of hydrocarbon reservoirs or geological storage of substances such as hydrogen and CO₂. Thus, the disclosed methods are integrated into the established practical applications for improving models of sedimentary basins and searching for an extraction of hydrocarbons from subsurface hydrocarbon reservoirs. The disclosed methods represent an improvement over existing methods for at least the reasons of lower cost and increased efficacy.

FIG. 1 shows a drilling system (100) in accordance with one or more embodiments. As shown in FIG. 1, a wellbore (118) following a wellbore trajectory (104) may be drilled by a drill bit (106) attached by a drillstring (108) to a drilling rig (110) located on the surface (124) of the earth. The drilling rig (110) may include framework, such as a derrick (114) to hold drilling machinery. A crown block (111) may be mounted at the top of the derrick (114), and a traveling block (113) may hang down from the crown block (111) by means of a cable (115) or drilling line. One end of the cable (115) may be connected to a drawworks (not shown), which is a reeling device that may be used to adjust the length of the cable (115) so that the traveling block (113) may move up or down the derrick (114).

A top drive (116) provides clockwise torque via the drive shaft (117) to the drillstring (108) in order to drill the wellbore (118). The drillstring (108) may comprise a plurality of sections of drillpipe attached at the uphole end to the drive shaft (117) and downhole to a bottomhole assembly (“BHA”) (120). The BHA (120) may be composed of a plurality of sections of heavier drillpipe and one or more measurement-while-drilling (“MWD”) tools configured to measure drilling parameters, such as torque, weight-on-bit, drilling direction, temperature, etc., and one or more logging-while-drilling (“LWD”) tools (135) configured to measure parameters of the rock surrounding the wellbore (118), such as electrical resistivity, density, sonic propagation velocities, gamma-ray emission, etc. The MWD tools and the logging tools (135) may include sensors and hardware to measure downhole drilling parameters, and these measurements may be transmitted to the surface (124) using any suitable telemetry system known in the art. The BHA (120) and the drillstring (108) may include other drilling tools known in the art but not specifically listed.

The wellbore (118) may traverse a plurality of overburden (122) layers and one or more seals or cap-rock formations (123) to a hydrocarbon reservoir, or “reservoir”, (102) within the subterranean region of interest (128), and specifically to a drilling target (130) within the reservoir (102). The wellbore trajectory (104) may be a curved or a straight. All or part of the wellbore trajectory (104) may be vertical, and some portions of the wellbore trajectory (104) may be deviated from the vertical or horizontal. One or more portions of the wellbore (118) may be cased with casing (132) in accordance with a wellbore plan.

To start drilling, or “spudding in” the well, the hoisting system lowers the drillstring (108) suspended from the derrick (114) towards the planned surface location of the wellbore (118). An engine, such as an electric motor, may be used to supply power to the top drive (116) to rotate the drillstring (108) through the drive shaft (117). The weight of the drillstring (108) combined with the rotational motion enables the drill bit (106) to bore the wellbore (118).

The drilling system (100) may communicate with other systems in, or far from, the well environment, such as a logging system (134), a geological modeling system (136), a seismic interpretation system (140), and a wellbore planning system (138). The drilling system (100) may control at least a portion of a drilling operation by providing controls to various components of the drilling operation. The drilling system (100) in operation may receive well-measured data from the logging system (134). The well-measured data may include mud properties, flow rates, drill volume and penetration rates, rock physical properties, etc.

The logging system (134) may include one or more logging tools (135), such as a nuclear magnetic resonance (NMR) logging tool and/or a resistivity logging tool, for use in generating well logs of the formation (123). For example, a logging tool (135) may be lowered into the wellbore (118) to acquire measurements as the tool traverses a depth interval (e.g., a targeted reservoir section) of the wellbore (118). The plot of the logging measurements versus depth may be referred to as a “log” or “well log”. Well logs may provide depth measurements of the wellbore (118) that describe such reservoir characteristics as formation porosity, formation permeability, resistivity, water saturation, and the like. The resulting logging measurements may be stored and/or processed, to generate corresponding well logs for the wellbore (118). A well log may include, for example, a plot of a logging response time versus true vertical depth (TVD) across the depth interval of the wellbore (118).

Geological data and seismic data (202) may be used by a geological modeling system (136) to create geological models of portions of the Earth's crust. A geological model is the numerical equivalent of a three-dimensional geological map complemented by a description of physical quantities in the domain of interest. As such, a geological modeling system (136) may assist in the management of natural resources, identification of natural hazards, and quantification of geological processes. For example, in the oil and gas industry, detailed 3D geological models are required as input to reservoir simulators, which predict the behavior of the rocks under various hydrocarbon recovery scenarios.

A geological modeling system (136) may be used by reservoir engineers to identify the most cost-effective development plan for a for a particular reservoir. A reservoir can only be developed and produced once, thus, identifying the site with the best conditions for reservoir development is an important task in the oil and gas industry.

A geological modeling system (136) may perform several key groups of functions, each serving a specific purpose in the construction of geological models. For example, steps may include a preliminary analysis of the geological context of the region of interest, interpretation of available data and observations as polygonal lines, and construction of a structural model describing the main rock boundaries (horizons, intrusions, faults). A three-dimensional mesh honoring the structural model may be defined to support a volumetric representation of heterogeneity. Another function the geological modeling system (136) may perform is the resolution of the Partial Differential Equations that govern the relevant physical processes in the subsurface (such as, for example, seismic wave propagation and fluid transport in porous media).

The geological modeling system (136) may provide visualization tools to render data and geological models in a visual format, enabling geoscientists to analyze, interpret, and perform visual quality control more effectively. This can include 2D/3D map displays, depth slices, horizon maps, and virtual reality visualization.

The final step involves generating reports and documenting the results of the geological modeling workflow. This includes recording the data processing parameters, interpretation results, and any uncertainties or limitations associated with the data.

The geological modeling system (136) may consist of various hardware components that work together to process and analyze geological and seismic data. Geological modeling requires significant computational power and storage capacity. High-performance servers and workstations are used to handle the massive amount of data and perform complex data processing algorithms efficiently. Input (geological and seismic) data can be massive, reaching terabytes or even petabytes in size. Reliable and high-capacity storage systems, such as Network Attached Storage (NAS) or Storage Area Networks (SAN), are utilized to store and manage the input data effectively. In some cases, where processing demands are extremely high, the geological modeling system (136) may utilize cluster systems. Clusters are groups of interconnected computers or servers that work together to distribute the processing workload, enabling parallel processing and faster data analysis. A robust and high-speed network infrastructure is vital for seamless data transfer between different components. This ensures efficient communication and data sharing, especially in multi-node or distributed environments.

The geological modeling system (136) may use GPUs for accelerating the computation of geological modeling algorithms. Despite advances in storage technology, data on tapes is still often used for long-term archiving and backup purposes. Tape systems provide high-capacity, cost-effective, and reliable storage solutions for geological data and seismic data. Various peripherals such as monitors, keyboards, mice, network switches, uninterruptible power supply (UPS), and backup power generators complete the hardware setup of a geological modeling system (136). These peripherals ensure smooth operation, user interaction, and data integrity.

On the other hand, a seismic interpretation system (140) is primarily used by geoscientists, seismic interpreters, and exploration teams in the oil and gas industry for analyzing seismic data to understand subsurface geological structures. Seismic interpreters use the workstation to visualize seismic data, including 2D and 3D seismic volumes, cross-sections, time slices, and attribute maps. These visualizations provide insights into subsurface structures, faults, and potential hydrocarbon reservoirs.

Interpreters may pick and interpret key geological horizons within seismic data to identify stratigraphic layers, boundaries, and structural features. Horizon interpretation tools and workflows allow for the accurate extraction of geological information from seismic volumes. A seismic interpretation system (140) enables interpreters to identify and interpret subsurface faults that may impact hydrocarbon reservoirs. Fault interpretation tools and visualization techniques help in understanding fault geometry, connectivity, and spatial relationships. Seismic attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

Interpreters may use 3D geological models and the seismic interpretation system (140) in estimating reservoir properties, optimizing well locations, and predicting hydrocarbon distribution. Interpreters may analyze and characterize hydrocarbon reservoirs by integrating different data sources, including seismic data, well logs, production data, and seismic inversion results. Workstations provide tools for reservoir property estimation, quantitative analysis, and reservoir performance evaluation.

The seismic interpretation system (140) may facilitate prospect generation and evaluation, where interpreters identify and assess areas with high hydrocarbon exploration potential. They can perform detailed geological and geophysical analysis, identify drilling targets, and quantify the risk and uncertainty associated with potential prospects. Finally, workstations enable interpreters to collaborate with team members, share interpretation results, and communicate findings effectively. Interpretation software allows for the creation of reports, annotated images, and presentations to communicate geological interpretations to stakeholders.

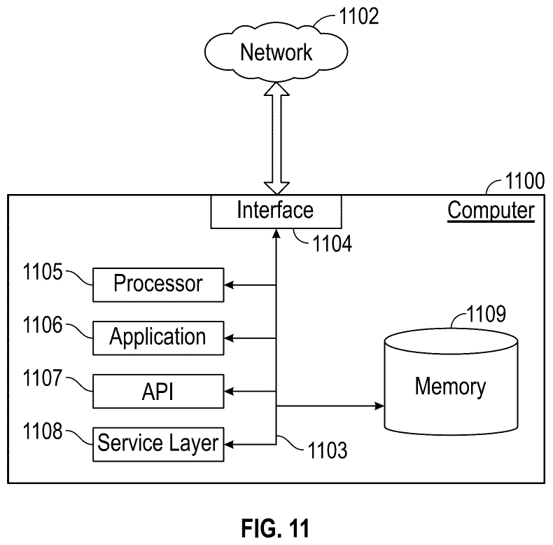

The seismic interpretation system (140) is an important tool for geoscientists involved in exploration and production activities, helping them make informed decisions about drilling locations, optimize production strategies, and understand complex subsurface geological structures. The seismic interpretation system (140) may be a specialized computer system used by geoscientists and seismic interpreters for analyzing and interpreting seismic data. The seismic interpretation system (140) may be implemented on a computing device such as that shown in FIG. 11.

Seismic interpretation involves intensive tasks like data visualization, horizon picking, attribute analysis, and 3D modeling. A high-performance seismic interpretation system (140) with a powerful processor, ample memory, and a high-resolution display is useful to handle these computationally demanding tasks efficiently. Dedicated GPUs may be crucial for real-time rendering of seismic data, enabling smooth and interactive visualization. GPUs with high memory and parallel processing capabilities accelerate tasks like volume rendering and horizon visualization.

Seismic interpretation often involves working with large and complex datasets. Multiple high-resolution monitors allow interpreters to view seismic data, cross-sections, time slices, attribute maps, and other visualizations simultaneously, enhancing productivity and analysis accuracy. The seismic interpretation system (140) may be equipped with industry-standard software applications tailored for seismic interpretation, such as seismic data processing and visualization tools, horizon and fault interpretation systems, attribute analysis software, and 3D modeling software.

Seismic interpretation projects generate substantial amounts of data, including seismic volumes, processed data, interpretation results, and velocity models. A high-capacity and fast storage system, such as solid-state drives (SSDs) or RAID arrays, is necessary to store and access this data efficiently. The seismic interpretation system (140) often requires network connectivity to access centralized data repositories, collaborate with colleagues, and share interpretation results. A robust network infrastructure with fast Ethernet or fiber connections ensures smooth data transfer and collaboration capabilities.

Essential peripherals like keyboards, mice, and graphics tablets enable efficient interaction with data and software interfaces. Additionally, color-calibrated and high-accuracy input devices enhance the precision of interpretation tasks like picking horizons or drawing geological features. The seismic interpretation system (140) should have backup solutions in place to protect valuable data from loss or damage. Automated backup systems, external storage devices, or network-attached storage (NAS) can be utilized to ensure data safety. In some cases, seismic interpreters may need remote access to the seismic interpretation system (140) or collaborate with colleagues remotely. Setting up remote access capabilities, such as Virtual Private Networks (VPNs) or remote desktop solutions, allows interpreters to work from different locations and share their work effectively. The seismic interpretation system (140) may be customized to meet the needs of interpreters and the specific requirements of projects. The hardware specifications may vary based on factors like the complexity of interpretations, the size of datasets, and the software tools utilized.

In some embodiments, the rock physical properties may be used by the seismic interpretation system (140) to determine a location of a reservoir (102) (or other subterranean features), including the drilling target (130). Knowledge of the existence and location of the reservoir (102) and other subterranean features may be transferred from the seismic interpretation system (140) to a wellbore planning system (138). The wellbore planning system (138) may use information regarding the reservoir (102) location to plan a well, including a planned wellbore trajectory (104) from the surface (124) of the earth to penetrate the reservoir (102). In addition, to the depth and geographic location of the reservoir (102), the planned wellbore trajectory (104) may be constrained by surface limitations, such as suitable locations for the surface position of the wellhead, i.e., the location of potential or preexisting drilling rigs, drilling ships or from a natural or man-made island.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Information regarding the planned wellbore trajectory (104) may be transferred to the drilling system (100) described in FIG. 1. The drilling system (100) may drill the wellbore (118) along the planned wellbore trajectory (104) to access the drilling target (130) in the reservoir (102).

A wellbore planning system (138) is used in the oil and gas industry for designing and planning drilling operations. It assists drilling engineers and teams in making strategic decisions related to wellbore placement, casing design, trajectory planning, and well path optimization. The wellbore planning system (138) allows drilling engineers to visualize and interact with wellbore data in a 3D environment. It provides a graphical representation of the planned well trajectory, existing well paths, geological formations, and potential hazards.

The wellbore planning system (138) integrates geological models, well logs, seismic data, and other subsurface information to facilitate the creation of accurate and realistic wellbore plans. By incorporating geological models, drilling engineers can optimize well placement in reservoir targets and avoid geohazards. Furthermore, the wellbore planning system (138) assist in designing optimal well trajectories based on reservoir targets, geologic constraints, and drilling objectives. Engineers can define well paths that maximize drilling efficiency, reach specific targets (horizontal or vertical), and account for geological formations and structural complexities.

The wellbore planning system (138) incorporates collision-avoidance algorithms to assess potential collision risks between nearby wells, salt bodies, or other subsurface infrastructure. By considering uncertainties in subsurface data and drilling conditions, the wellbore planning system (138) may assess collision probabilities for planned well paths. This analysis helps in quantifying risks associated with collision potential and improving well placement decisions. The wellbore planning system (138) provides real-time alerts to prevent wellbore collisions and maintain drilling safety.

The wellbore planning system (138) helps drilling engineers in designing casing strings and selecting appropriate tubulars based on the wellbore conditions, planned drilling operations, and regulatory requirements. It considers factors such as pressure, temperature, well depth, formation properties, and casing load capacity. Furthermore, the wellbore planning system (138) performs torque and drag analysis to evaluate the forces and stresses acting on the drillstring during drilling operations. This analysis helps in identifying potential issues such as differential sticking, buckling, or limitations in the drilling equipment.

The wellbore planning system (138) may have the capability to integrate real-time drilling data, such as downhole measurements, drilling parameters, and formation evaluation results. This integration allows engineers to monitor the drilling progress, make on-the-fly adjustments to the well plan, and optimize drilling efficiency. Furthermore, the wellbore planning system (138) provides tools for generating reports, exporting data, and documenting drilling plans and decisions. These reports can be shared with regulatory agencies, drilling contractors, and other stakeholders to ensure alignment and compliance throughout the drilling lifecycle.

The wellbore planning system (138) assists drilling engineers in designing optimal well trajectories, minimizing risks, and maximizing drilling efficiency. They integrate various subsurface data sources, perform complex analyses, and provide visualization tools to support informed decision-making in well planning and drilling operations.

As noted, the drilling system (100) may provide well logs either through measurement tools at the BHA (120) while drilling or by post-drilling surveys such as a wireline tool (not shown). Furthermore, data about formations (123) near a well site may be obtained by analyzing the entrained cuttings, as a function to drilling depth, exiting the wellbore (118). In addition to data acquired at a well-site, other methods for collecting data and characterizing formations (123) exist. For example, a seismic survey may be conducted.

For brevity, only a condensed description of a seismic acquisition system is included herein, however, this brief description is non-limiting as one with ordinary skill in the art will appreciate that a seismic acquisition system may be configured in myriad of ways without departing from the scope of the present disclosure. For example, a seismic acquisition system may be conducted with a variety of seismic sources, such as an airgun or vibroseis truck, and with a plurality of seismic receivers. Typically, the seismic source generates radiated seismic waves which may be reflected by geological discontinuities in the formations (123) and may be returned to the surface and subsequently detected by the seismic receivers. In some cases, a single seismic source may be activated sequentially at various source locations. In other cases, multiple seismic sources positioned at different locations may be activated sequentially. Additionally, multiple seismic sources may be activated during the same time period, or during overlapping time periods. The waves are recorded by the seismic receivers as a time-series representing the amplitude of ground-motion at a sequence of discreet sample times. The time-series records constitute seismic data. Once acquired, seismic data may undergo a myriad of processing steps. The purposes of these processing steps include, but are not limited to, reducing signal noise, identifying subsurface structures and surfaces, and data visualization.

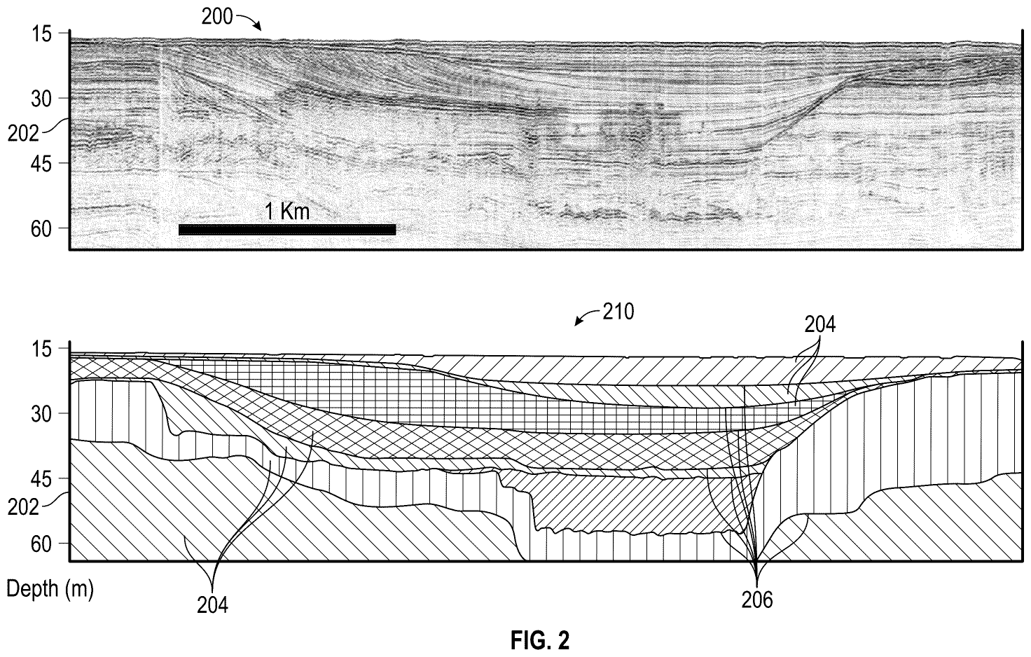

FIG. 2 shows examples of seismic images formed from seismic data. Seismic image (200) depicts various layers representing surfaces which reflected seismic source waves at various depths in a subsurface region of interest. The seismic image may be evaluated by a subject matter expert using a seismic interpretation system (140) to further describe the subsurface region of interest. The seismic interpretation system (140) may use the seismic image (200) to identify one or more geological units (204) and various sequence boundaries (206), as those illustrated in Panel (210).

Sets of geological data from a plurality of wells, which may include subsurface logs and/or petrophysical logs, and a seismic data may be collected and processed to provide lithology information over a subsurface region of interest. Moreover, so-called “soft” geological data, such as outcrop information and data describing analogous modern depositional environments may be integrated with the acquired well site data and seismic data to further refine the modeled subsurface formations (123) over a subterranean region of interest (128). The model of the subsurface region of interest may include information about the spatial distribution of subsurface formation (123) properties such as, but not limited to: porosity; mineral content; chemical makeup; and density. Additionally, the model of the subsurface region may include information about the formation (123) geological unit (204) thicknesses. Regions of subsurface formations (123) may be given qualitative lithology designations like “limestone”, “wackestone”, “silty-sand”, etc. based on the measured and modeled subsurface properties. Lithology designations are herein referred to as lithotypes. A more granular description of the subsurface formations (123) may be defined using percentages of lithotypes. For example, a subsurface region and a stratigraphic region therein may be described as being 60% grainstone and 40% packstone.

In some embodiments, data characterizing rocks and fluids within the reservoir (102) may be transferred by the seismic interpretation system (140) to a reservoir simulator. A reservoir simulator comprises functionality for simulating the flow of fluids, including hydrocarbon fluids such as oil and gas, through a reservoir composed of porous, permeable reservoir rocks in response to natural and anthropogenic pressure gradients. The reservoir simulator may be used to predict changes in fluid flow, including fluid flow into wellbore (118) penetrating the reservoir (102) as a result of planned well drilling, and fluid injection and extraction. For example, the reservoir simulator may be used to predict changes in hydrocarbon production rate that would result from the injection of water into the reservoir (102) from wells around the reservoir's periphery.

The reservoir simulator may use a subsurface model that contains a digital description of the physical properties of the rocks as a function of position within the subsurface region of interest and the fluids within the pores of the porous, permeable reservoir rocks at a given time. In some embodiments, the digital description may be in the form of a dense 3D grid with the physical properties of the rocks and fluids defined at each node. In some embodiments, the 3D grid may be a cartesian grid, while in other embodiments the grid may be an irregular grid.

The physical properties of the rocks and fluids within the reservoir (102) may be obtained from a variety of geological and geophysical sources. For example, seismic acquisition systems, such as seismic surveys, gravity surveys, and active and passive source resistivity surveys, may be employed. In addition, data collected by logging systems (134) such as well logs, production data as previously discussed, acquired in wells penetrating the reservoir (102) may be used to determine physical and petrophysical properties along the segment of the wellbore trajectory (104) traversing the reservoir (102). For example, porosity, permeability, density, seismic velocity, and resistivity may be measured along these segments of wellbore. In accordance with some embodiments, seismic data determined by seismic acquisition systems and physical and petrophysical properties determined from well logs may be combined to estimate physical and petrophysical properties for the entire reservoir simulation model grid.

As stated above, a geological modeling system (136) may account for, among other things, the porosity and hydrocarbon storage capacity of the subsurface formations (123) and fluid transport pathways to predict the production rate of hydrocarbons of a well, or a set of wells, over their lifetime. As such, accurate subsurface models are critical to reduce exploration risks, plan the location of well sites, optimize reservoir production, improve reservoir characterization, best leverage existing discoveries, and better extend hydrocarbon recovery from existing wells. One type of subsurface model is a depositional model.

Depositional models, broadly defined, are process-based models which seek to reproduce the geological time evolution of a geographic region. Depositional models are powerful because depositional sequences directly correlate to formation (123) properties. Formations (123) are produced and affected by geological processes. These geological processes include depositional processes such as sediment transport and syn-depositional and post-depositional processes such as diagenesis, including compaction and cementation.

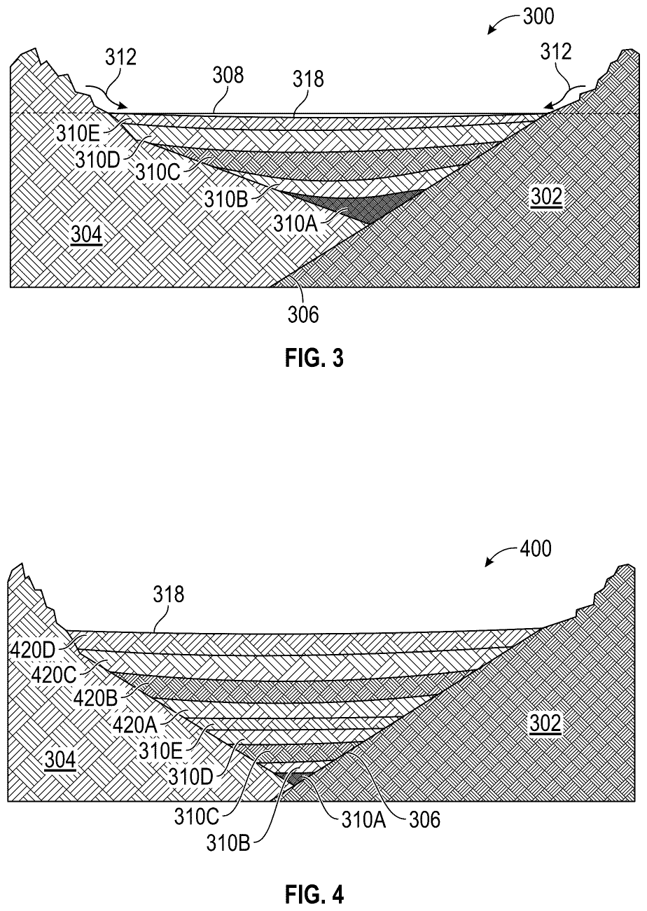

FIGS. 3 and 4 depict a single exemplary sedimentary basin (300), in accordance with one or more embodiments. In FIG. 3 the sedimentary basin (300) is depicted at an earlier geological time or “archaic time.” This time may be many tens of millions of years before the present-day. The sedimentary basin (300) may comprise a pre-existing basement rock (302, 304). This basement rock (302, 304) may be an igneous rock, a metamorphic rock, or may be a preexisting sedimentary rock. In some embodiments, the basement rock may be divided into a first basement rock (302) and a second basement rock (304) separated by a geological fault (306). The first basement rock (302) and a second basement rock (304) may be of the same rock type or they may be of different rock types.

Within the sedimentary basin (300) flows of sediment (312) originating in surrounding regions may accumulate on the ground surface (318) of the sedimentary basin (300). The ground surface (318) of the sedimentary basin may be below sea level (308) as depicted in FIG. 3, in which case the sedimentary basin may be filled with seawater. In other cases, the ground surface (318) of the sedimentary basin (300) may be partially or wholly occupied by a lake or by a river system, or by any combination of river, lake and sea. At the archaic time the sedimentary basin (300) may be filled by a plurality of sedimentary layers (310A, 310B, 310C, 310D, 310E) deposited at earlier times during the creation and earlier history of the sedimentary basin (300). Different types of rock layers may be created by different environmental conditions during their deposition. For example, without limitation, fine-grained mudstone may be deposited in deep water, sandstone with uniform grain sizes may be deposited in beach or shallow water environments, shales or coals may be deposited in marsh or swamp environments, and coarse-grained conglomerates may be deposited in fast-flowing river environments.

Different types of rock may have different petrophysical and geomechanical properties at the time they are deposited. Even rock categorized as the same, such as sandstone, may have petrophysical and geomechanical properties that differ from other samples of the same type. For example, one sandstone may have 40% porosity while another sandstone may have only 26% porosity. Petrophysical properties may include, without limitation, porosity, permeability and total organic content. Geomechanical properties may include, without limitation, Young's modulus, Poisson's ratio, bulk modulus, compaction coefficient and friction angle.

Over a geological timescale a sedimentary basin may evolve. In particular, a sedimentary basin may deepen, and additional sedimentary layers may be deposited above those that existed at an archaic time shown in FIG. 3. For example, the sedimentary basin may deepen because the underlying basement blocks may be pulled apart from one another by tectonic forces, or the basement rocks may cool causing their density to increase and the basement rocks to settle deeper. In such cases, the flows of sediment into the sedimentary basin may deposit additional sedimentary layers burying the archaic sedimentary layers to greater depths and compressing them under greater pressures.

FIG. 4 depicts an example of a present-day sedimentary basin (400). Sedimentary layers (420A, 420B, 420C, 420D) deposited between the archaic time, depicted in FIG. 3, and the present-day, depicted in FIG. 4, may cause alteration of the petrophysical and geomechanical property values of the underlying archaic sedimentary layers. For example, the compaction of the underlying sedimentary layers may cause a reduction in porosity. Prior to the removable of the rock core from the sedimentary layer, the pores may be filled with gas, including natural gas or methane, or with liquids such as oil, fresh water or brine.

Over geological time, compaction by the weight of overlying layers may reduce the porosity of a sedimentary layer. The reduction of the porosity may be the result of physical processes, such as elastic or plastic deformation of the solid grains, or mechanical failure, i.e., the breaking of grains. In addition, the reduction of the porosity may be the result of chemical processes, such as the dissolution and/or deposition of minerals, or the transformation portions of grains from one mineral to another denser and more compact mineral. Further, the reduction in porosity may be a result of biological processes, such as the bacterial fermentation of organic matter.

Depositional processes affect reservoir architecture, govern fluid flow, and may define stratigraphic compartments. Depositional models include the capability to create a gross depositional environment (GDE) map which represents the depositional environment, that when coupled with other geological processes, produces the subsurface region of interest. Typically, GDE maps are created using data from a plurality of subsurface logs (e.g., well logs, petrophysical logs) processed to provide lithology information over a subsurface region of interest. Additionally, data acquired from a seismic survey, or data collected from offset wells or outcrops may be incorporated in the creation of a GDE map. One with ordinary skill in the art will appreciate that many modifications and processing techniques may be applied to the modeling and/or construction of GDE maps. As such, the previously provided general description do not impose a limitation on the present disclosure.

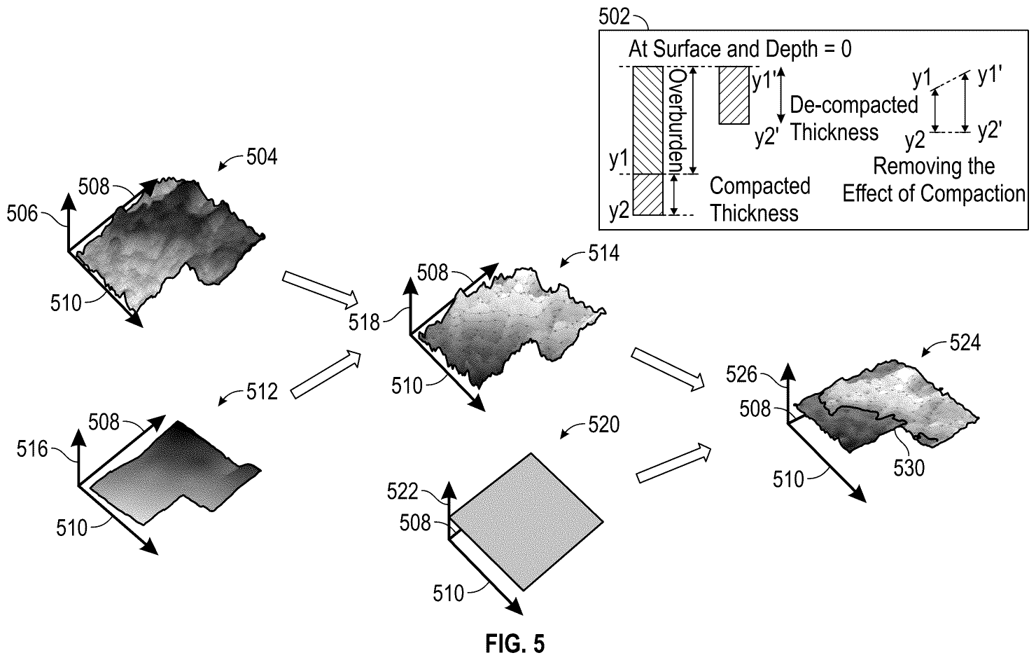

Tuning to FIG. 5, FIG. 5 shows an example of generating a three-dimensional (3D) paleogeographic surface, in accordance with one or more embodiments. The modeling procedure may involve a 3D digital reconstruction of the paleo bathymetry associated with a depositional environment. The process may begin with modeling seismic surfaces using estimated thickness data of geological units, and other geophysical data, acquired from a seismic survey. Once the seismic surfaces have been modeled, they are further processed by a decompaction model to transform the thicknesses of the geological units to decompacted thicknesses, as illustrated schematically in Panel 502 of FIG. 5.

In some embodiments, decompaction modeling may make use of a depth map, a thickness map, and lithology map, all of them derived by interpretation of seismic data or well data, or by geostatistical interpolations between data points. Seismic data may be calibrated and tied to the well data, and a structural model may be used to acquire the thickness and the depth map. A lithology may be constructed from lithology descriptions in the well data as well as by statistical analysis of seismic data.

Decompaction modeling may be performed by simulating a decompaction process, that provides to decompacted thicknesses, i.e., the initial thickness of the geological units at the time of deposition:

$$y {2}^{′} = y 2 - y 1 - \frac{{φ}_{i}}{{c}_{0}} [ exp ( - {c}_{0} * y 1 ) - exp ( - {c}_{0} * y 2 ) ] + \frac{{φ}_{i}}{{c}_{0}} [ exp ( - {c}_{0} * y {1}^{′} ) - exp ( - {c}_{0} * y {2}^{′} ) ] \qquad Equation ( 1 )$$

where y2-y1 is the thickness at depth, y1 is the present-day depth at the top of the unit, y2 is the present-day depth at the base of the formation unit, and y2′ is the decompacted thickness. y1′ is the formation depth at the surface which is 0. The parameter φᵢ is the porosity at the time of deposition and c₀ is a compaction coefficient. Decompaction modeling may include solving Eq. 1 by applying input parameters φᵢ and c₀ and removing the effects of the overburden.

A decompacted thickness surface (504) is illustrated in FIG. 5. The decompacted thickness of the layer of interest is indicated on the vertical thickness axis (506) for each horizontal spatial position indicated on the orthogonal axes (508) and (510). This decompacted thickness surface (504) is a result of applying Equation (1) to the compacted thickness and depth of the upper surface of the current layer for each location.

The decompacted thickness surface (504) may be subsequently combined with a total relief map (512) to generate a relative topographic surface (514). The vertical axis (516) shows the elevation of each point on the total relief map (512). The total relief map (512) shows the paleo-topography, i.e., the elevation of the surface on which the layer of interest was initially deposited at and may be based, at least in part, on a Gross Depositional Environment (GDE) map of the region of interest. Combination of the decompacted thickness surface (504) with the total relief map (512) provides an adjustment to the decompacted thickness, because the decompacted thickness may represent only a fraction of the available accommodation space in some cases, such as in underfilled areas like deep marine and pro-delta areas. The total relief map (512), which is based on geological interpretations (the GDE map), may be employed for the adjustment.

As stated above, the relative topographic surface (514) is obtained after decompaction modeling produced by combining the decompacted thickness surface (504) and the total relief map (512). The vertical axis (518) shows the relative elevation of the upper surface of the layer of interest at the time at which deposition of the layer ended.

FIG. 5 also illustrates a uniform vertical bulk shift (520), indicated on the vertical axis (522), that may be combined with the relative topographic surface (514) to determine the final 3D paleogeographic surface (524). Elevation with respect to sea-level at the time of deposition is shown on the vertical axis (526). Once the final 3D paleogeographic surface (524) is obtained, particular geological features may be identified, such as, for example, a coastline (530) at the time of deposition.

Despite the attempt to correct the paleogeographic surface (524) with the total relief map (512), a large degree of uncertainty is introduced by the total relief map (512). The large uncertainties are inevitably transferred to the resulting paleogeographic surface (524). Methods for reducing uncertainties in the process of generating paleogeographic surfaces (524) may assist in the accurate prediction of present-day hydrocarbon reservoir quality.

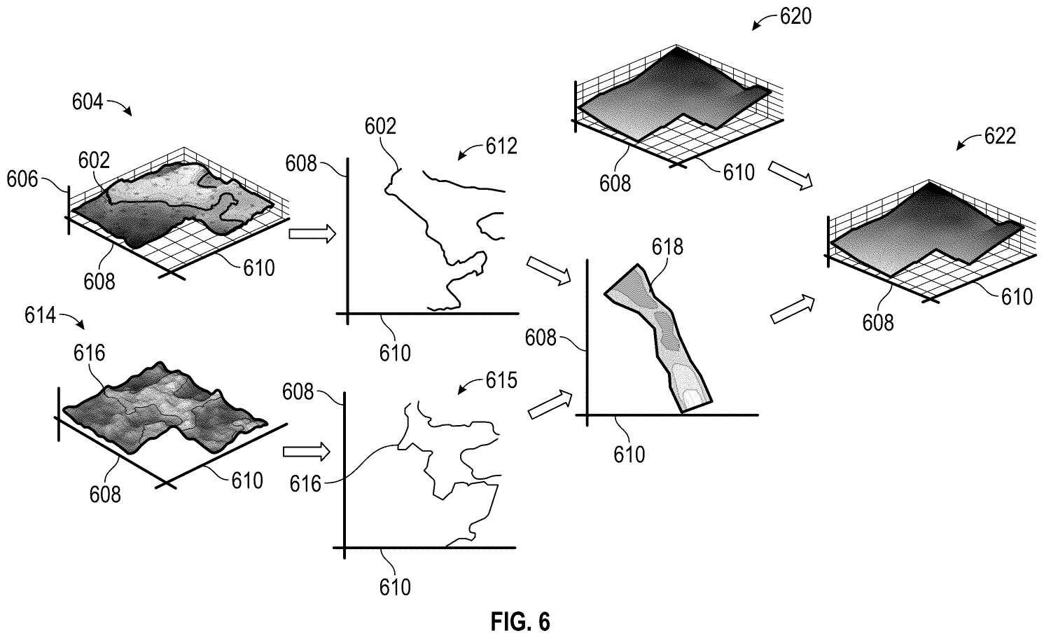

Turning to FIG. 6, FIG. 6 shows a diagram for calibrating a total relief map with a seismic attribute, according to one or more embodiments. FIG. 6 includes an input paleographic surface (604), a surface of a seismic attribute (614), an initial total relief map (620) and an updated total relief map (622). The surface of the seismic attribute (614) may be, for example, a horizon, and is obtained from seismic data. The calibration may begin with a selection of a first plurality of calibration points, or contour, that may represent, for example, the coastline (602) of the paleogeographic surface (604). The vertical axis (606) indicates the elevation with respect to sea-level at the time of deposition for each horizontal spatial position indicated on the orthogonal axes (608) and (610). The first plurality of calibration points (612), i.e., the extracted contour (the coastline (602) in FIG. 6), may be defined in two spatial dimensions, given by the orthogonal axes (608) and (610).

A second plurality of calibration points (615) may be extracted from the surface of the seismic attribute (614) and may be also given by a contour of the seismic attribute (614) that captures the adjustable geological attribute, as the horizon (616). The second plurality of calibration points (615) may be also defined in two orthogonal spatial dimensions (608) and (610). To facilitate the calibration procedure, the coastline (602) and the horizon (616) may be discretized using a common grid in the system of two orthogonal spatial dimensions (608) and (610).

The calibration procedure may be oriented to update the paleogeographic surface (604) until it matches the surface of the seismic attribute (614) using a calibration surface (618). To generate the calibration surface, a measure may first be implemented to quantify the difference between the first plurality of calibration points (612) and the second plurality of calibration points (615).

In some embodiments, each point of the first plurality of calibration points (612) may be expressed as a function of a spatial dimension, say the coordinate x, as follows:

$$y = {f}_{1} ( x ) \qquad Equation ( 2 )$$

In a similar manner, each point of the second plurality of calibration points (615) may be expressed as and as a function of the x-coordinate:

$$y = {f}_{2} ( x ) \qquad Equation ( 3 )$$

For each point (xₘ, yₘ) of the first plurality of calibration points (612) there may be a corresponding point (xₙ, yₙ) in the second plurality of calibration points (615). The Euclidean distance between these two points is then given by

$$d = d ( x , y ) = \sqrt{{( {x}_{n} - {x}_{m} )}^{2} + {( {y}_{n} - {y}_{m} )}^{2}} \qquad Equation ( 4 )$$

For a given value xᵢ in the (x, y) plane that contains the first and the second plurality of points, the Euclidean distance may be simplified to:

$${d}_{i} = {f}_{2} ( {x}_{i} ) - {f}_{1} ( {x}_{i} ) \qquad Equation ( 5 )$$

In other embodiments, the difference measure may be a distance d between the point (xₘ, yₘ) of the first plurality of calibration points (612) and the point (xₙ, yₙ) of the second plurality of calibration points (615) that is also perpendicular to either the tangent at (xₘ, yₘ), or to the tangent at (xₙ, yₙ). The slope of the tangent at each point is simply the derivative of the contour of interest at that point. For example, the slope of the tangent Sᵢ at the point [xᵢ, f₁ (xᵢ)] may be approximated with a finite difference:

$${S}_{i} = \frac{{f}_{1} ( {x}_{i} + h ) - {f}_{1} ( {x}_{i} - h )}{2 h} \qquad Equation ( 6 )$$

where h is the change in the x-coordinate. Then the equation of the normal at xᵢ, i.e., the line perpendicular to the tangent at xᵢ, may be expressed as:

$$N ( x ) = \frac{- 1}{{S}_{i}} x + C \qquad Equation ( 7 )$$

where C is a constant representing the intercept of N(x) which may be determined by evaluating Eq. (7) at the point [xᵢ, f₁ (xᵢ)]. The x-coordinate xⱼ of the point of intersection between the normal N(x) and the contour of the second plurality of calibration points (615) may be obtained by solving the equation:

$${f}_{2} ( x ) = \frac{- 1}{{S}_{i}} x + C \qquad Equation ( 8 )$$

The perpendicular distance d may then be obtained with the following expression:

$$d = \sqrt{{( {x}_{j} - {x}_{i} )}^{2} + {[ {f}_{2} ( {x}_{j} ) - {f}_{1} ( {x}_{i} ) ]}^{2}} \qquad Equation ( 9 )$$

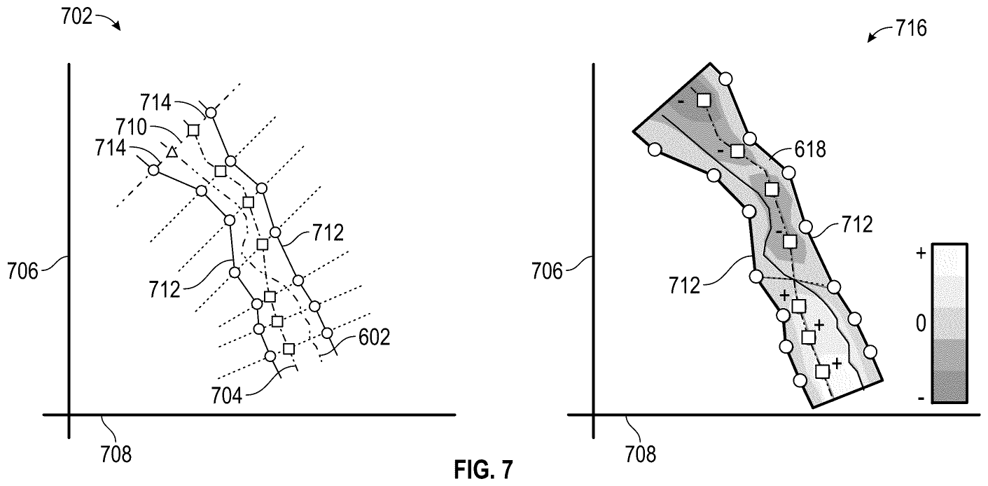

With the distances d determined for all points (xₘ, yₘ) and all points (xₙ, yₙ), the calibration surface (618) may then be constructed. An example of generating a calibration surface will be presented in FIG. 7 below.

Once the calibration surface (618) is generated it may be used to update the paleogeographic surface (604). Since uncertainties associated to the total relief map (620) may be large, the total relief map (620) may be the chosen surface to be calibrated. Thus, an updated total relief map (622) may be generated by a combination of the total relief map (620) and the calibration surface (618). The values of the total relief map may be adjusted in the region corresponding to the calibration surface (618). For example, depth values may be shifted according to the shift values provided by the calibration surface (618). In some embodiments, the total relief map (620) is discretized in the same spatial grid as the calibration surface (618) and the calibration of the total relief map (620) may include a product obtained by performing scalar multiplication of the total relief map (620) and the calibration surface (618). The depth values of the total relief map (620) may then be shifted according to the product and only where the product has non-zero values.

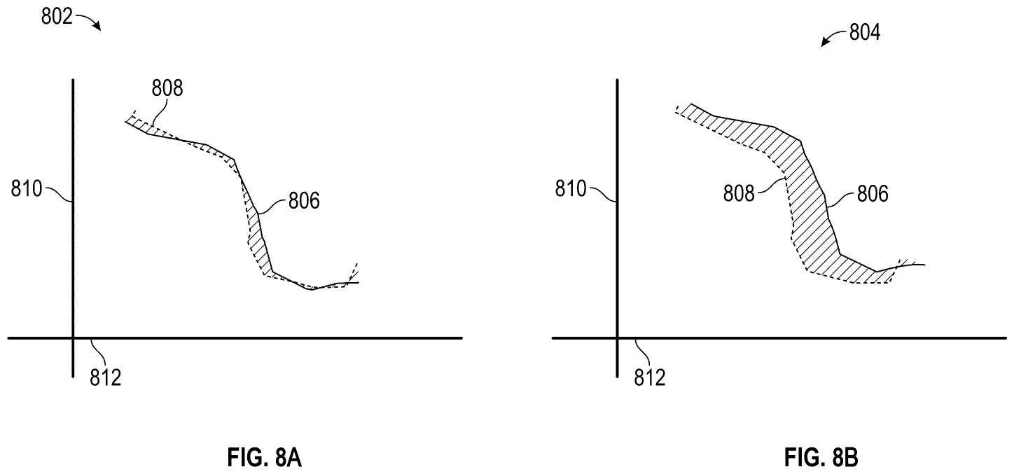

In some embodiments, validation of the updated paleogeographic surface depends on a measure of a difference between the updated paleogeographic surface and the surface of the seismic attribute (614). For example, a difference between a predetermined value and an average distance between the updated paleogeographic surface and the surface of the seismic attribute (614) may be used. More specifically, the average distance may correspond to a distance between the contour of an updated first plurality of calibration points (612) and an updated adjustment curve. The updated first plurality of calibration points (612) and the updated adjustment curve may be determined using the updated paleogeographic surface. An example of an average distance between the updated paleogeographic surface and the surface of the seismic attribute will be presented in FIGS. 8A and 8B below.

Turning to FIG. 7, FIG. 7 shows schematically an example of generating a calibration surface, in accordance with one or more embodiments. In Panel (702) the contour from the coastline (602) and an “adjustment curve” (704) are plotted in the same plane of two orthogonal spatial dimensions (706) and (708). The adjustment curve (704) including a plurality of adjustment points, may represent a correction, or “shift” to be applied to the paleogeographic surface (604) for calibration. In some embodiments the adjustment curve (704) may be simply points extracted from the surface of the seismic attribute (614), such as the second plurality of calibration points (615). In other embodiments, the adjustment curve (704) may be a weighted combination of the points (xₘ, yₘ), (xₙ, yₙ), and the distance d (710), as given, for example, by the following expression:

$${y}_{f} = {w}_{1} {f}_{1} ( {x}_{i} ) + {w}_{2} [ {f}_{1} ( {x}_{i} ) + {d}_{i} ] \qquad Equation ( 10 )$$

where w₁ is a weight assigned to the first plurality of calibration points (612), and w₂ is a weight assigned to the second plurality of calibration points (615). Weights w₁ and w₂ are introduced to take into account the uncertainties associated with the adjustable geological attribute and the seismic attribute, respectively. Thus, in the case large uncertainties are related to the adjustable geological attribute, weights w₁=0 and w₂=100% may be adopted, the adjustment curve (704) may reduce to the plurality of points extracted from the surface of the seismic attribute (614).

Once the adjustment curve (704) is determined, the calibration surface (618) is generated by defining a region of non-zero shift in plane of two orthogonal spatial dimensions (706) and (708). The shift may be considered to have its peaks at the adjustment curve (704) and to reduce to zero towards the envelope (712) delimiting the calibration surface (618). The envelope (712) may be defined based on the distances d (710). In FIG. 7 the distance d (710) is the distance between the points of the adjustable geological attribute (the coastline (602) in FIG. 6) and the adjustment curve (704), that is perpendicular to the curve formed by the points of the adjustable geological attribute. The envelope (712) delimiting the calibration surface (618) may be then determined by adding extensions (714) to the distance d (710), on both ends of the distance d (710), as shown in Panel (702). The length of each extension (714) may be a user's choice, and may be, for example half the distance d (710), d/2.

At the envelope (712) and outside the calibration surface (618) the shift values may be assumed to be zero. As seen in Panel (716) the shift values may be negative or positive inside the calibration surface (618) and tend to zero towards the envelope (712). The shift values at points inside the calibration surface (618) may be determined by interpolation. Points for interpolation may be determined, for example, by adding discretization points of the adjustment curve (704) in the direction of the x-coordinate. In some embodiments, interpolation is performed using cubic spline interpolation for points added along the normal N(x). In other embodiments, interpolation is performed between points of the adjustment curve (704) and the envelope (712).

Turning to FIGS. 8A and 8B, FIGS. 8A and 8B illustrates the concept of the average distance that may be used to validate the updated paleogeographic surface. In FIG. 8A (802) and FIG. 8B (804), the updated first plurality of calibration points (806) and the also updated adjustment curve (808) are plotted in the same plane of two orthogonal spatial dimensions (810) and (812). The difference between the average distance being less than a predetermined value may be the condition that validates the updated paleogeographic surface. The predetermined value may be user's choice. For example, if the average distance between the updated first plurality of calibration points (806) and the updated adjustment curve (808) is less than 1% of the length of the paleogeographic surface (524) in one chose spatial direction, as it is the case in FIG. 8A (802), the updated paleogeographic surface may be considered validated and the stopping condition of the procedure may be reached. On the contrary, in FIG. 8B (804) the average distance between the updated first plurality of calibration points (806) and the updated adjustment curve (808) is larger than 1%. In this case the updated paleogeographic surface may be considered as not completely calibrated.

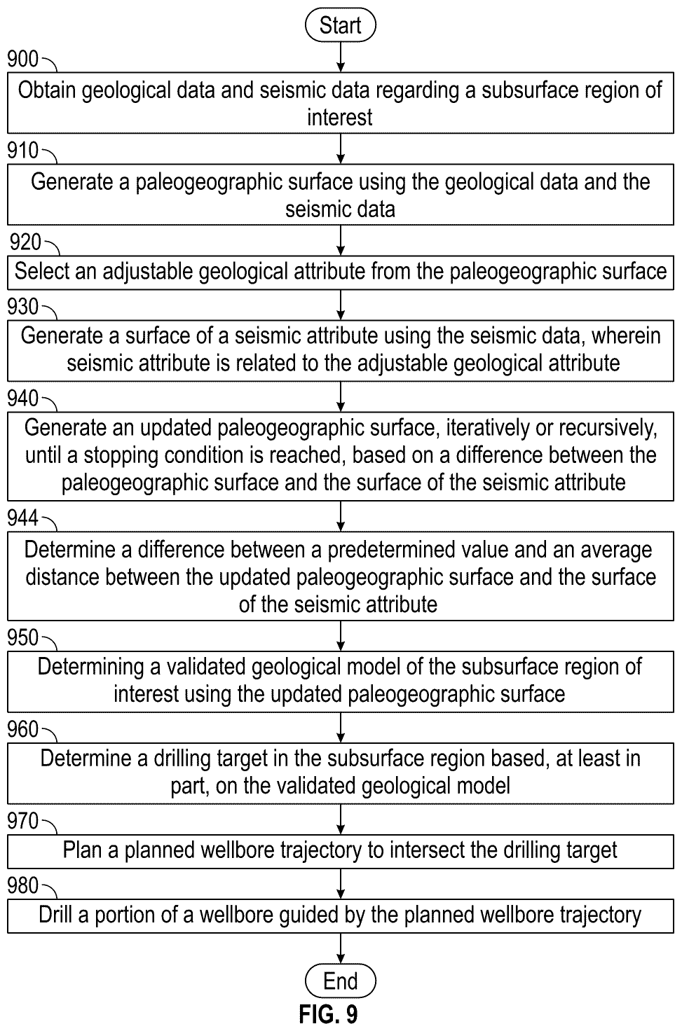

Turning to FIG. 9, FIG. 9 shows a flowchart in accordance with one or more embodiments. Specifically, FIG. 9 describes an embodiment of the inventive method to calibrate and update a paleographic surface. While the various blocks in FIG. 9 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 900, geological data and seismic data associated with a subterranean region of interest (128) may be obtained, in accordance with one or more embodiments. The seismic data may be acquired using a seismic acquisition system above the subterranean region of interest (128). The seismic data may be processed to attenuate noise and may be organized in one or more spatial dimensions and a time axis to form a plurality of time-space waveforms. The geological data may be collected from a plurality of wells, including offset wells, in the form of well logs. The data may also include other petrophysical logs, “soft” data such as information from outcrop-reservoir analogue descriptions, or any other data as previously described.

In Block 910, a paleogeographic surface using the geological data and the seismic data is generated, in accordance with one or more embodiments. The construction of a paleogeographic surface may include the superposition of a total relief map (512) and a decompacted thickness surface (504). The total relief map (512) may be based, at least in part, on a GDE map resulting from geologic analysis of the region of interest and related uncertainties. The GDE map may include information on the erosional relief (areas that have been eroded by the overlying strata and processes). The decompacted thickness surface (504) may be constructed using present-day burial depth, thickness, and a lithology map, all of which may be obtained from seismic data constrained by well log data.

In some embodiments, generating a paleogeographic surface (524) also includes superposition with a bulk shift (520) to move a relative topographic surface (514) to the coastline (530) or to a geological feature of interest that has a specific contour.

In Block 920, an adjustable geological attribute is selected from the paleogeographic surface (524), in accordance with one or more embodiments. The adjustable geological attribute may be selected to reduce uncertainties in the paleogeographic surface (524) by comparing with a seismic attribute derived from seismic data. Non-limiting examples of adjustable geological attributes include paleo-shorelines (or coastlines), shelf edges, erosion surfaces or contours delimiting the spatial extent of paleo-highs. A coastline (530) is the zero (0) iso-line in a paleogeographic surface (524). A shelf edge may be defined by a combination between a strong slope discontinuity and isoline, below the coastline. The erosion edge may be a contour located above the coastline.

In Block 930, a surface of a seismic attribute is generated using the seismic data, in accordance with one or more embodiments. The seismic attribute is related to the adjustable geological attribute. Specifically, the seismic attribute may be sensitive to changes due to paleogeomorphological phenomena (e.g., weathering, erosion, shoreline striatal geometries, etc.) The seismic attribute and the adjustable geological attribute may represent similar features in the paleogeography.

A non-limiting example of a seismic attribute that may be used to detect changes related to paleogeomorphology is seismic attenuation. Seismic attenuation may be used to characterize the medium (rock) of propagation of the seismic waves travel. Subaerial exposure of rocks of structural highs subjects the exposed rocks to weathering and erosion. The changes in the rock's mechanical properties by weathering and erosion affect the attenuation of seismic waves traveling through the rocks. Seismic attenuation may then be used a seismic attribute suitable to calibrate a paleogeographic surface (524) by correlating high attenuation zones with weathered paleo-highs.

The surface of the seismic attribute and paleogeographic surface (524) may be in the same format or transformed to the same format. The surface of the seismic attribute may be resampled with resampling parameters that match the lateral resolution of the paleogeographic surface (524). The surface of the seismic attribute may be further processed to smooth out noise and short-wavelength signals.

In Block 940, an updated paleogeographic surface is generated, iteratively or recursively, until a stopping condition is reached, based on a difference between the paleogeographic surface and the surface of the seismic attribute, in accordance with one or more embodiments. The difference between the paleogeographic surface (524) and the surface of the seismic attribute may orient how the paleogeographic surface (524) is updated in each iteration. One or more seismic attributes and their corresponding surfaces may be used depending on the target paleogeographic surface (524) to be updated.

The updating process may be performed in way that does not alter the input parameters and the process to generate the decompacted thickness surface (504), which may follow a standard industry workflow and may be associated to the low uncertainties of observed input data. Most large uncertainties are considered to originate from the interpretation of geological data used to generate the GDE map, and thus, the total relief map (512).

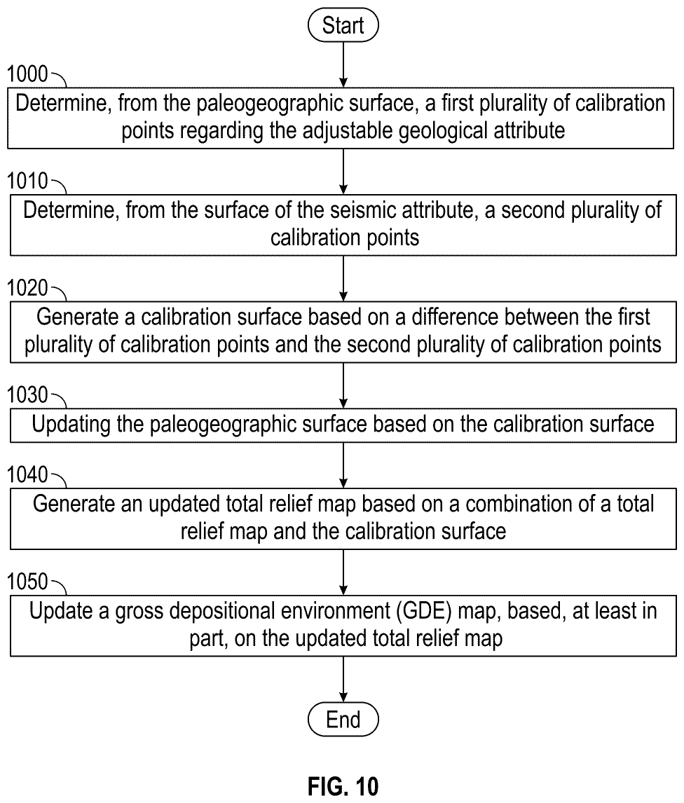

An example of a method for updating a paleogeographic surface is illustrated by the flowchart of FIG. 10, in accordance with one or more embodiments. The remaining steps of the method of FIG. 9 are presented below, after the discussion of FIG. 10. In Block 1000 of FIG. 10, a first plurality of points regarding the adjustable geological attribute may be determined. In some embodiments, the first plurality of points, may represent, for example, contours of geological boundaries. The geological boundaries may correspond, for example, to a paleo-shoreline, a shelf edge, or an erosional surface boundary. All of these geological boundaries can be mapped and extracted from the paleogeographic surface, such as the paleographic surface (604) of FIG. 6. The first plurality of points may represent, for example, the coastline (602) of the paleogeographic surface (604).

The adjustable geological attribute and corresponding boundaries that may be available for calibration depends on the specific geology of the area of interest. The use of multiple adjustable geological attributes may be more effective in reducing uncertainties. However, in some areas of interest, only one adjustable geological attribute may be available.

In Block 1010 a second plurality of calibration points (615) may be determined from the surface of the seismic attribute. The surface of the seismic attribute (614) may be obtained from seismic data. If, for example, seismic attenuation is used as a seismic attribute, contours separating high and low attenuation values may be extracted to be correlated with contours delimiting areas of paleo-highs. In some embodiments, the second plurality of calibration points (615) may be extracted from the surface of the seismic attribute (614) and may be also given by a contour of the seismic attribute (614).

In Block 1020 a calibration surface may be generated, based on a difference between the first plurality of calibration points (612) and the second plurality of calibration points (615). A measure may first be implemented to quantify the difference between the first plurality of calibration points (612) and the second plurality of calibration points (615). Measures that may be used to quantify the difference include the Euclidean distance and a distance along normal directions of a contour, or any other difference measure known in the art.

In some embodiments the contour is generated using an adjustment curve (704) that may represent a correction, or “shift” to be applied to the paleogeographic surface (604). The adjustment curve (704) may be, for example, simply points extracted from the surface of the seismic attribute (614). In some embodiments, the adjustment curve (704) may use a weighted combination of the first plurality of calibration points (612) and the second plurality of calibration points (615). The weights may take into account the uncertainties associated with the calibration points.

The adjustment curve (704) may be used to determine a region of non-zero shift. The adjustment curve (704) may determine the locations where the non-zero shift has its peaks. The difference between the first plurality of calibration points (612) and the second plurality of calibration points (615) may be used to define envelope (712) towards which the non-zero shift reduces to zero.

In some embodiments, the shift is zero at the envelope (712) and outside the calibration surface (618). The shift values at points inside the calibration surface (618) may be determined by interpolation, such as linear interpolation, cubic spline interpolation, or any other interpolation technique known in the art. Interpolation points may be added starting from the adjustment curve (704) towards one or more spatial dimensions. In some embodiments, interpolation points may be added along a direction normal to first or second plurality of calibration points.

In Block 1030, the paleogeographic surface (604) may be updated based on the calibration surface (618), in accordance with one or more embodiments. In some embodiments, an updated total relief map (622) may be updated based on a combination of the calibration surface (618) and the total relief map (620), as shown in Block 1040. Specifically, the total relief map (620) may be adjusted in the region corresponding to the calibration surface (618). The calibration surface may provide shift values to correct the depth values of the total relief map (620). In some embodiments, the total relief map (620) and the calibration surface (618) are discretized using the same spatial grid, and the total relief map (620) may be updated based on scalar multiplication of the total relief map (620) and the calibration surface (618). The depth values of the total relief map (620) may then be updated only where the scalar multiplication has non-zero values.

The updated total relief map (622) may be incorporated in the method of generating a paleogeographic surface. By combining with the decompacted thickness surface (504) and subsequently with the bulk shift (520), an updated paleogeographic surface may be obtained.

In Block 1050, a gross depositional environment (GDE) map may be updated based, at least in part, on the updated total relief map (622), in accordance with one or more embodiments. Updating the GDE map with the updated total relief map (622) may improve the accuracy of the GDE map, providing in turn improvements in subsequent tasks, such as better estimates of reservoir quality, enhanced characterization and visualization of the subsurface region of interest, improved reservoir simulation models, and improved projections of hydrocarbon production.

Returning to FIG. 9, in Block 944, a difference between a predetermined value and an average distance between the updated paleogeographic surface and the surface of the seismic attribute (614) may be determined, in accordance with one or more embodiments. The average distance may be the distance between the contour of an updated first plurality of calibration points (612) and an updated adjustment curve. The updated first plurality of calibration points (612) and the updated adjustment curve may be determined using the updated paleogeographic surface. The difference between the average distance being less than a predetermined value may be the condition that validates the updated paleogeographic surface. The predetermined value may be user's choice. If the average distance is larger than the predetermined value, the updated paleogeographic surface may be used as an input paleogeographic surface (604) in a new iteration in the calibration procedure.

In Block 950, a validated geological model of the subsurface region of interest is determined using the updated paleogeographic surface, in accordance with one or more embodiments. The updated paleogeographic surface may be used alongside a GDE map and other collected data such as well logs, petrophysical logs, and seismic data to generate a geological model of the subsurface region of interest (i.e., form a subsurface model), inform a wellbore planning system (138), and plan a well site and wellbore trajectory.

In Block 960, a drilling target in the subsurface region is determined based, at least in part, on the validated geological model, in accordance with one or more embodiments. A drilling target (130) in a wellbore (118) may be determined by the seismic interpretation system (140), and may be based on, for example, an expected presence of gas or another hydrocarbon. Locations in a validated geological model may be delimited by geological boundaries and may indicate a probability of the presence of a hydrocarbon. Locations in a validated geological model may indicate an elevated probability of the presence of a hydrocarbon and may be targeted by well designers. On the other hand, locations in a validated geological model indicating a low probability of the presence of a hydrocarbon may be avoided by well designers.

In Block 970, a planned wellbore trajectory to intersect the drilling target is planned, in accordance with one or more embodiments. Knowledge of the location of the drilling target (130) and the validated geological model may be transferred by the seismic interpretation system (140) to a wellbore planning system (138). Instructions associated with the wellbore planning system (138) may be stored, for example, in the memory (1109) within the computer system (1100) described in FIG. 11 below. The wellbore planning system (138) may use the knowledge of the location of the drilling target (130) and of validated geological model to plan a wellbore trajectory (104) within the subterranean region of interest (128).

In Block 980, a wellbore is drilled guided by the planned wellbore trajectory, in accordance with one or more embodiments. The wellbore planning system (138) may transfer the planned wellbore trajectory (104) to the drilling system (100) described in FIG. 1. The drilling system (100) may drill a portion of the wellbore (118) along the planned wellbore trajectory (104) to access and produce the reservoir (102) to the surface (124).

In some embodiments the wellbore planning system (138), the seismic interpretation system (140), and geological modeling system (136) may each be implemented within the context of a computer system. FIG. 11 is a block diagram of a computer system (1100) used to provide computational functionalities associated with described algorithms, methods, functions, processes, flows, and procedures as described in the instant disclosure, according to an implementation. The illustrated computer (1100) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1100) may include a computer that includes an input device, such as a keypad, keyboard, touch screen, or other device that can accept user information, and an output device that conveys information associated with the operation of the computer (1100), including digital data, visual, or audio information (or a combination of information), or a GUI.

The computer (1100) can serve in a role as a client, network component, a server, a database or other persistency, or any other component (or a combination of roles) of a computer system for performing the subject matter described in the instant disclosure. The illustrated computer (1100) is communicably coupled with a network (1102). In some implementations, one or more components of the computer (1100) may be configured to operate within environments, including cloud-computing-based, local, global, or other environment (or a combination of environments).

At a high level, the computer (1100) is an electronic computing device operable to receive, transmit, process, store, or manage data and information associated with the described subject matter. According to some implementations, the computer (1100) may also include or be communicably coupled with an application server, e-mail server, web server, caching server, streaming data server, business intelligence (BI) server, or other server (or a combination of servers).

The computer (1100) can receive requests over network (1102) from a client application (for example, executing on another computer (1100)) and responding to the received requests by processing the said requests in an appropriate software application. In addition, requests may also be sent to the computer (1100) from internal users (for example, from a command console or by other appropriate access method), external or third-parties, other automated applications, as well as any other appropriate entities, individuals, systems, or computers.

Each of the components of the computer (1100) can communicate using a system bus (1103). In some implementations, any or all of the components of the computer (1100), both hardware or software (or a combination of hardware and software), may interface with each other or the interface (1104) (or a combination of both) over the system bus (1103) using an application programming interface (API) (1107) or a service layer (1108) (or a combination of the API (1107) and service layer (1108). The API (1107) may include specifications for routines, data structures, and object classes. The API (1107) may be either computer-language independent or dependent and refer to a complete interface, a single function, or even a set of APIs. The service layer (1108) provides software services to the computer (1100) or other components (whether or not illustrated) that are communicably coupled to the computer (1100). The functionality of the computer (1100) may be accessible for all service consumers using this service layer (1108). Software services, such as those provided by the service layer (1108), provide reusable, defined business functionalities through a defined interface. For example, the interface may be software written in JAVA, C++, or other suitable language providing data in extensible markup language (XML) format or other suitable format. While illustrated as an integrated component of the computer (1100), alternative implementations may illustrate the API (1107) or the service layer (1108) as stand-alone components in relation to other components of the computer (1100) or other components (whether or not illustrated) that are communicably coupled to the computer (1100). Moreover, any or all parts of the API (1107) or the service layer (1108) may be implemented as child or sub-modules of another software module, enterprise application, or hardware module without departing from the scope of this disclosure.

The computer (1100) includes an interface (1104). Although illustrated as a single interface (1104) in FIG. 11, two or more interfaces (1104) may be used according to particular needs, desires, or particular implementations of the computer (1100). The interface (1104) is used by the computer (1100) for communicating with other systems in a distributed environment that are connected to the network (1102). Generally, the interface (1104) includes logic encoded in software or hardware (or a combination of software and hardware) and operable to communicate with the network (1102). More specifically, the interface (1104) may include software supporting one or more communication protocols associated with communications such that the network (1102) or interface's hardware is operable to communicate physical signals within and outside of the illustrated computer (1100).

The computer (1100) includes at least one computer processor (1105). Although illustrated as a single computer processor (1105) in FIG. 11, two or more processors may be used according to particular needs, desires, or particular implementations of the computer (1100). Generally, the computer processor (1105) executes instructions and manipulates data to perform the operations of the computer (1100) and any algorithms, methods, functions, processes, flows, and procedures as described in the instant disclosure.

The computer (1100) also includes a memory (1109) that holds data for the computer (1100) or other components (or a combination of both) that may be connected to the network (1102). For example, memory (1109) may be a database storing data consistent with this disclosure. Although illustrated as a single memory (1109) in FIG. 11, two or more memories may be used according to particular needs, desires, or particular implementations of the computer (1100) and the described functionality. While memory (1109) is illustrated as an integral component of the computer (1100), in alternative implementations, memory (1109) may be external to the computer (1100).

The application (1106) is an algorithmic software engine providing functionality according to particular needs, desires, or particular implementations of the computer (1100), particularly with respect to functionality described in this disclosure. For example, application (1106) can serve as one or more components, modules, applications, etc. Further, although illustrated as a single application (1106), the application (1106) may be implemented as multiple applications (1106) on the computer (1100). In addition, although illustrated as integral to the computer (1100), in alternative implementations, the application (1106) may be external to the computer (1100).

There may be any number of computers (1100) associated with, or external to, a computer system containing computer (1100), each computer (1100) communicating over network (1102). Further, the term “client,” “user,” and other appropriate terminology may be used interchangeably as appropriate without departing from the scope of this disclosure. Moreover, this disclosure contemplates that many users may use one computer (1100), or that one user may use multiple computers (1100).

In some embodiments, the computer (1100) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining, by a geological modeling system, geological data and seismic data regarding a subsurface region of interest;
generating, by the geological modeling system, a paleogeographic surface using the geological data and the seismic data;
selecting an adjustable geological attribute from the paleogeographic surface;
generating, using a seismic interpretation system, a surface of a seismic attribute using the seismic data,
wherein the seismic attribute is related to the adjustable geological attribute, and
wherein the seismic interpretation system is coupled to the geological modeling system;
generating, by the geological modeling system, an updated paleogeographic surface, iteratively or recursively, until a stopping condition is reached, based on a difference between the paleogeographic surface and the surface of the seismic attribute; and
determining, by the geological modeling system, a validated geological model of the subsurface region of interest based, at least in part, on the updated paleogeographic surface.

2. The method of claim 1, further comprising determining, by a seismic interpretation system, a drilling target in the subsurface region based, at least in part, on the validated geological model.

3. The method of claim 2, further comprising:
planning, using a wellbore planning system, a planned wellbore trajectory to intersect the drilling target; and
drilling, using a drilling system, a portion of a wellbore guided by the planned wellbore trajectory.

4. The method of claim 1, wherein the adjustable geological attribute is paleo-topography.

5. The method of claim 1, wherein the seismic attribute is seismic attenuation.

6. The method of claim 1, wherein the difference comprises a Euclidean distance.

7. The method of claim 1, wherein the stopping condition comprises determining a difference between a predetermined value and an average distance between the updated paleogeographic surface and the surface of seismic attributes.

8. The method of claim 1, wherein generating an updated paleogeographic surface comprises:
determining, from the paleogeographic surface, a first plurality of calibration points regarding the adjustable geological attribute;
determining, from the surface of the seismic attribute, a second plurality of calibration points;
generating a calibration surface based on a difference between the first plurality of calibration points and the second plurality of calibration points; and
updating the paleogeographic surface based on the calibration surface.

9. The method of claim 8, wherein generating the calibration surface comprises determining a plurality of adjustment points based on a weighted combination of the first plurality of calibration points and the second plurality of calibration points.

10. The method of claim 8, wherein updating the paleogeographic surface comprises generating an updated total relief map based on a combination of a total relief map and the calibration surface.

11. The method of claim 10, further comprising updating a gross depositional environment (GDE) map based, at least in part, on the updated total relief map.

12. A system comprising:
a seismic acquisition system configured to record seismic data regarding a subsurface region of interest;
a logging system coupled to a plurality of logging tools configured to record geological data regarding the subsurface region of interest;
a seismic interpretation system configured to generate a surface of a seismic attribute using the seismic data; and
a geological modeling system coupled to the seismic interpretation system and configured to:
obtain the geological data from the logging system and the seismic data from the seismic acquisition system,
generate a paleogeographic surface using the geological data and the seismic data,
select an adjustable geological attribute from the paleogeographic surface, wherein the adjustable geological attribute is related to the seismic attribute,
generate an updated paleogeographic surface, iteratively or recursively, until a stopping condition is reached, based on a difference between the paleogeographic surface and the surface of the seismic attribute, and
determine a validated geological model of the subsurface region of interest based, at least in part, on the updated paleogeographic surface.

13. The system of claim 12, wherein the seismic interpretation system is further configured to determine a drilling target in the subsurface region based, at least in part, on the validated geological model.

14. The system of claim 13, further comprising:
a wellbore planning system configured to plan a planned wellbore trajectory to intersect the drilling target; and
a drilling system configured to drill a portion of a wellbore guided by the planned wellbore trajectory.

15. The system of claim 12, wherein the adjustable geological attribute is paleo-topography.

16. The system of claim 12, wherein the seismic attribute is seismic attenuation.

17. The system of claim 12, wherein the geological modeling system is further configured to determine a difference between a predetermined value and an average distance between the updated paleogeographic surface and the surface of seismic attributes.

18. The system of claim 12, wherein the geological modeling system is further configured to:
determine, from the paleogeographic surface, a first plurality of calibration points regarding the adjustable geological attribute;
determine, from the surface of the seismic attribute, a second plurality of calibration points;
generate a calibration surface based on a difference between the first plurality of calibration points and the second plurality of calibration points; and
update the paleogeographic surface based on the calibration surface.

19. The system of claim 18, wherein the geological modeling system is further configured to determine a plurality of adjustment points based on a weighted combination of the first plurality of calibration points and the second plurality of calibration points.

20. The system of claim 18, wherein the geological modeling system is further configured to generate an updated total relief map based on a combination of a total relief map and the calibration surface.
